(19) United States
(12) Patent Application Publication
(10) Pub. No.: US 2007/0100843 A1
(43) Pub. Date: May 3, 2007

(54) System and method for mapping between different information management systems

(76) Inventors: Daniel Q. Chen, Chelmsford, MA (US); Michael L. Quigley, Brookline, NH (US); Amal A. Shaheen, Austin, TX (US); John P. Woods, Lexington, MA (US)

Correspondence Address: Greg Goshorn, P.C., 9600 Escarpment, auite 745-9, AUSTIN, TX, 78749, US

(21) Appl. No.: 11/255,197

(22) Filed: Oct. 20, 2005

(51) Int. Cl. G06F 7/00

(52) U.S. Cl. 707/100

(57) ABSTRACT

Provided is a method for the standardization of information management among different information sources and different information formats. With respect to information sources that employ different information storage formats, an organizational proxy, or “shadow,” of the organization structure of the first information source is created in the second information source and a shadow of the second information source is created in the first information source. Information stored in conjunction with the first information source is copied into the shadow within the second information source. The information in the first source is then either maintained or a link to corresponding information in the second information source is created within the first information source and the first information is deleted. The claimed subject matter provides a graphical user interface (GUI) so that a user can copy information from one information source to another by executing a “drag & drop” action.

### TECHNICAL FIELD

The present invention relates generally to information management and, more specifically, to a method for providing information exchange among different information management systems.

### BACKGROUND OF THE INVENTION

Over the years, the computing arts have advanced in many different directions. Currently, there are many types of computers, from small tablet computers to large mainframes, and several different operating systems (OSs), such as Windows published by the Microsoft Corporation of Redmond, Wash., AIX, published by the International Business Machines Corp. (IBM) of Armonk, N.Y., and Linux, which was originally developed by Linus Torvalds and is now an open source product supported by many companies and individuals around the world. Typically, OSs provide an information management system (IMS) in the form of a hierarchical, tree structured, file system.

In addition to multiple types of computers and OSs, there are many types of application and middleware software found on computing systems. A few examples include word processing applications, spreadsheets and presentation processing software such as Microsoft (MS) Word, MS Excel and MS Powerpoint, respectively, all published by the Microsoft Corporation. Other examples of document processing applications include various Lotus software programs and IBM Document Manager, both published by IBM. For the sake of simplicity, different types of computers, OSs and applications will all be referred to as information management systems (IMSs).

Documents in an IMS may be divided into two or more subsets of information. For example, a word processing document can be divided into subdocuments, one includes the text of the original document and others that include figures and/or graphs. The original (text) document is described as “subset 1” and the figures and/or graphs as subsets 2, 3, . . . etc. Sometimes it may be beneficial to store different subsets of information in different IMSs, while still being able to associate these different subsets of information.

Another example of an IMS is represented by e-mail systems, an important class of IMSs. Sophisticated e-mail systems allow users to compose a message using a built-in editor, attach one more documents to a message, and organize messages in an information navigational tree, which is explained in more detail below. In the disclosed technology, an original e-mail message is considered as the first (or main) subset of the information, while attachments are considered as subsets 2, 3, . . . etc. Documents attached to each message can be of any format: text, word processing, presentation, or even a video clip.

Sometimes it is beneficial to the user to organize such attachments in an IMS other than the email IMS, such as, but not limited to, the IBM Document Management System or an OS file system, while maintaining the association to the original e-mail message. E-mail systems that manage information through an information Navigation tree typically work as described below. An e-mail system usually has a “default root folder”, in which the user can move messages received in his Inbox after reading them. The user can create a set of folders in the default folder to represent different categories, e.g. Trips, HR, or Projects folders. Within each these folders, the user can create yet another set of folders. For example, in the “Projects” folder, the user can create “Project1, Project2, and so on folders, thus creating an Information Navigation Tree. When a message received in the Inbox (with or without attachments”, the user can file it under the appropriate category folder: HR related messages can be filed in the HR folder, messages related to Project 1 can be saved in the Project1 folder in the Projects folder.

The diversity of IMSs may also create issues when a user needs to associate documents in different IMSs to each other. Typically, different information management systems store and manage information using different mechanisms, and sometimes it is beneficial to manage and associate documents from different IMSs together as mentioned in the examples above, e.g. an e-mail system in which the e-mail message is stored in one IMS (the e-mail system) and the attachments are stored in another IMS, such that an OS file system. What is needed is a system that enables different computing systems and applications to offer a standardized mechanism to associate documents in different IMSs to each other. Ideally, a user would be able to select a document in one IMS, and have access to associated documents in other IMSs. In other words, what is needed is a uniform system for storing documents in one information hierarchy that enables the documents to be both retrieved easily within that information hierarchy and potentially retrieved from other information hierarchies as well.

### SUMMARY OF THE INVENTION

Provided is a method for mapping information organization among different information sources and different information formats. Examples of different sources include, but not limited to, email, file systems native to operating systems (OSs) and various document management systems. Examples of specific sources include such programs as Lotus Notes and IBM Workplace, both published by the International Business Machines Corp. (IBM) of Armonk, N.Y., and the file system provided with Microsoft Windows, published by the Microsoft Corp. of Redmond, Wash.

With respect to information sources that employ different information management formats, an organizational proxy, or “shadow,” of the organization structure of the first information source is created in the second information source and a shadow of the second information source is created in the first information source. Information management structure in conjunction with the first information source is copied into the shadow within the second information source. The information in the first source is then either maintained or a link to corresponding information in the second information source is created within the first information source and the first information is deleted.

The claimed subject matter provides a graphical user interface (GUI) so that a user can copy information from one Information Management System, referred to as source, to another by executing a “drag & drop” action or programmatically through the Application Programming Interfaces (APIs) of a second Information Management System.

This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description.

### BRIEF DESCRIPTION OF THE DRAWINGS

A better understanding of the present invention can be obtained when the following detailed description of the disclosed embodiments is considered in conjunction with the following drawings.

FIG. 1 is a block diagram of an exemplary computing system that employs the claimed subject matter.

FIG. 2 is an illustration of a graphical user interface (GUI) associated with an IBM Lotus Notes email application.

FIG. 3 is an illustration of a GUI associated with an IBM Workplace Document Management system.

FIG. 4 is an illustration of a GUI associated with a typical computing system file structure.

FIG. 5 is a flowchart of an exemplary Move Message process for implementing the claimed subject matter.

FIG. 6 is a flowchart of a portion of the Move Message process first introduced above in conjunction with FIG. 5

FIG. 7 is a flowchart of an exemplary Delete Message process for implementing the claimed subject matter.

### DETAILED DESCRIPTION OF THE FIGURES

Although described with particular reference to document storage mechanisms, the claimed subject matter can be implemented in any information technology (IT) system in which exchange, or mapping, or information management structure is desirable. Those with skill in the computing arts will recognize that the disclosed embodiments have relevance to a wide variety of computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory or recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for creating a shadow information structure of one information management structure within a second information management structure, and automating the organization and synchronization of “documents” between two Information Management Systems, both supporting hierarchical (or tree structure) management of information. The term “programmed method”, as used herein, is defined to mean one or more process steps that are presently performed; or, alternatively, one or more process steps that are enabled to be performed at a future point in time. The term programmed method anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

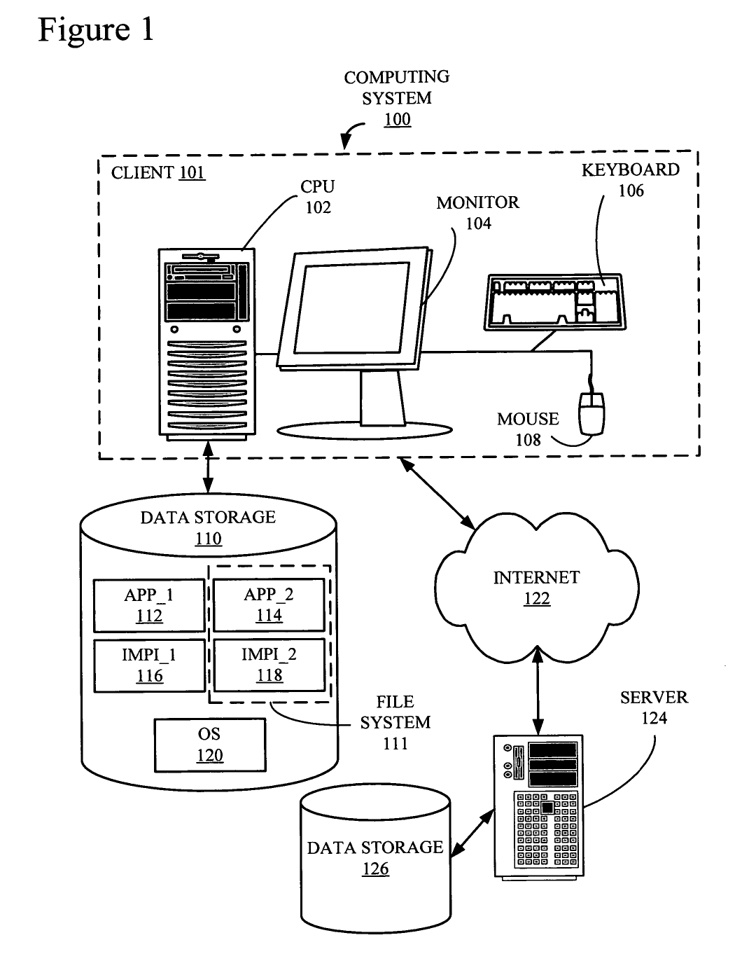

Turning now to the figures, FIG. 1 is a block diagram of an exemplary computing system architecture 100 that incorporates the claimed subject matter. A central processing unit (CPU) 102 is coupled to a monitor 104, a keyboard 106 and a mouse 108, which together facilitate human interaction with computing system 100. Collectively, components 102, 104, 106 and 108 are referred to as a client system, or client, 101.

Attached to CPU 102 is a data storage component 110, which may either be incorporated into CPU 102 i.e. an internal device, Client 101, or attached externally to client 101 by means of various, commonly available connection devices such as but not limited to, a universal serial bus (USB) port (not shown). Data storage 110 is partially organized around a file system 111, which for the purposes of the claimed subject matter a type of IMS. Data storage 110 is illustrated storing several exemplary applications, including a first application, or “app_1,” 112, and a second application, or “app_2,” 114. In the following examples, app_112 is an instantiation of IBM Lotus Notes, and app_2 114 employs native OS File System 111 as an IMS. Of course those with skill in the computing arts should appreciate that there are many applications that could implement and benefit from the claimed subject matter. Another such example is IBM workplace. Applications 112 and 114 are typical user applications used for illustrative purposes. For the sake of simplicity, only two exemplary applications are shown.

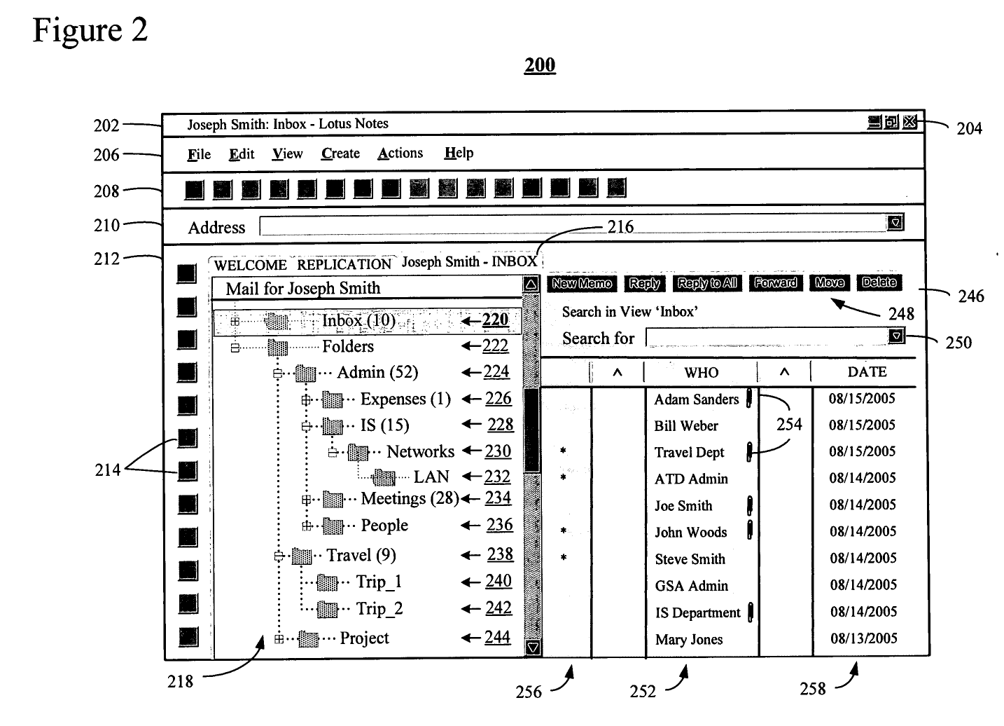

In this example, the claimed subject matter is implemented with respect to app_1 112 by means of a first information management plug-in, or “IMPI_1,” 116. The claimed subject matter is implemented with respect to app_2 114 by means of a second information management plug-in, or “IMPI_2,” 118. It should be noted that, for some file systems, this plug-in can be as simple as calls to the published file system Application Programming Interfaces (APIs). IMPI_1 116 and IMPI_2 118 are described in more detail below in conjunction with FIGS. 2-5. It should also be understood that there are many ways, other than plug-ins, to implement the claimed subject matter. For example, file system interrupts executed in conjunction with an operating system (OS) 120 and file system 111 could also be employed.

Client system 101 is connected to the 122, which is also connected to a server computer 124. Server 124 is coupled to a data storage 126. Like data storage 110, data storage 126 may either be incorporated into server 124 i.e. an internal device, or attached externally to CPU 124 by means of various, commonly available connection devices such as but not limited to, a universal serial bus (USB) port (not shown). Although in this example, Client 101 and server 124 are communicatively coupled via the Internet, they could also be coupled through any number of communication mediums such as, but not limited to, a local area network (LAN) (not shown).

FIG. 2 is an illustration of a graphical user interface (GUI) 200 associated with a first exemplary hierarchical structure, i.e. app_1 112 (FIG. 1), which in this example is IBM Lotus Notes. GUI 200 is typically executed on a computing system such as computing system 100 (FIG. 1) and displayed on a computer monitor such as monitor 104 (FIG. 1).

In this example, GUI 200 includes a title bar 202 that lists the name and specific implementation of app_1 112, or “Joseph Smith: Inbox—Lotus Notes.” In other words, GUI 200 is an exemplary display of an email box associated with IBM Lotus Notes and a hypothetical user Joseph Smith. Title bar 202 includes several action buttons 204, or a “Minimize” button, a “Restore” button and an “Exit” button. Below title bar 202 is a menu bar 206, which includes a “File” option, “Edit” option, “View” option, “Create” option, “Actions” option and “Help” option. The standard look and feel of a IBM Lotus Notes application should be familiar to those with skill in the art.

Below menu bar 206 are a number of actions icons 208 that enable a user to execute various functions in conjunction with GUI 200. Examples of functions that may be executed via action icons 208 include, but are not limited to, screen navigation, edit operations, viewing options and various file operations. Action buttons 204, menu bar 206 and action icons 208 may include fewer, more, or different buttons and/or icons than those illustrated. An address bar 210 enables the user to navigate through different screens that may be displayed within GUI 200.

An email display 212 of app_1 112 includes various action buttons 214, only two of which, for the sake of simplicity, are enumerated. Action buttons 214 enable the user to execute various actions with respect to email display 212 in general and specific emails in particular. Examples of actions associated with email display 212 include, but are not limited to, creating new messages and folders, navigation to a Calendar or Contacts screen. A vertical scroll bar on the right side of email display 212 enables entries in a Directory Structure 218 that are not displayed due to size constraints of monitor 104 to be scrolled into view.

Directory structure 218 illustrates the organizational hierarchy of directories associated with app_1 112. With the IBM Lotus Notes system, as exemplified by app_1 112, an Inbox 220 is a graphical representation of a directory in which current emails are stored. Inbox 220 is highlighted in this example to indicate that the information contained within Inbox 220 is currently displayed in a textbox 246. Typically after receiving a particular email in Inbox 220, a user files, or “moves,” the email to a sub-folder within Folders directory 222. This move action both frees space in the Inbox 220, which may have system imposed limits, and enables the user to organize email according to a hierarchical structure of the user's choosing. In other words, Folders 222 is a place to store email messages in a hierarchical manner so that Inbox 220 can be restricted to a manageable size.

Folders directory 222 includes sub-folders, including an Admin folder 224, a Travel sub-folder 238 and a Project sub-folder 244. Admin folder 224 includes an Expenses sub-folder 226 an IS sub-folder 228, a Meetings sub-folder 234 and a People sub-folder 236. IS folder 228 includes a Networks sub-folder 230, which itself includes a local area network (LAN) subfolder 232. Travel folder 238 includes information on two business trips, a Trip_1 240 and a Trip_2 242. Numerals following particular folder names, such as the number ‘10’ following the name of Inbox 220 indicate the number of email messages stored in the corresponding folder. In this example, Inbox 220 includes ten (10) individual email messages, specifically the ten messages displayed in text box 246. It should be noted that the illustrated folders and sub-folders are used only for the sake of examples and any particular implementation of the claimed subject matter may include additional, different, less and/or the same folders.

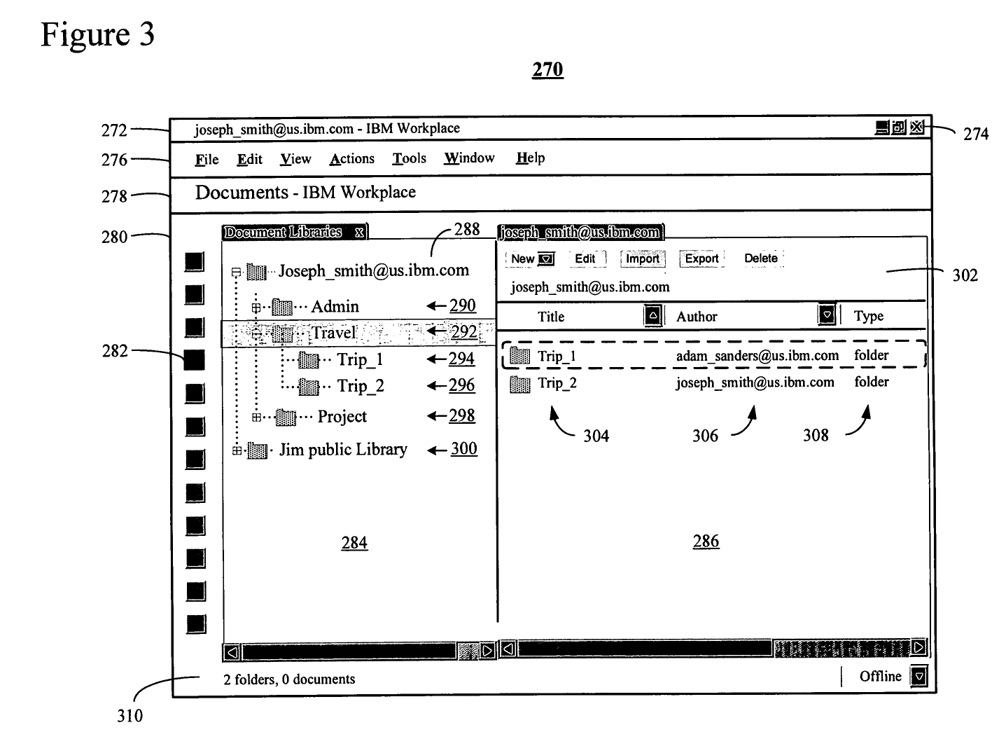

As mentioned above, highlighting around Inbox 220 indicates that email messages in Inbox 220 are displayed in more detail in text box 246. Text Box 246 includes a few action buttons 248, i.e. a New Memo button, a Reply button, a Reply-to-All button, a Forward button and a Delete button. Those with skill in the computing arts should recognize buttons 248 and appreciate their basic functions. The claimed subject matter also provides buttons 248 with new functionality as described below in conjunction with FIGS. 3-6. As explained above in conjunction with FIG. 1, in the following examples the claimed subject matter with respect to app_1 112 is implemented by IMPI_1 116.

A Search For box 250 enables a user to find specific email messages within text box 246. A name column 252 displays the sender of a particular email. In this example, there are email messages from Adam Sanders, Bill Weber, Travel Department, ATD Admin, Joe Smith, John Woods, Steve Smith, GSA Admin, IS Department and Mary Jones. Paper clip icons 254 following some of the email listings indicate that the corresponding emails include an attachment, i.e. a file that has been sent in conjunction with the email message. For the sake of simplicity, only two paper clip icons 254 are enumerated. A priority column 256 indicates that corresponding email messages have a higher importance than others. A Date column 258 indicates the date that the corresponding email was received.

The claimed subject matter addresses how the attachments to email messages, represented by paper clip icons 254, are handled. Of particular interest are actions represented by the Move and Delete buttons of action buttons 248.

FIG. 3 is an illustration of a GUI 270 associated with a second exemplary hierarchical structure, i.e. IBM Workplace Document Management system or, in this example, app_2 114 (FIG. 1). GUI 270 is typically executed on a computing system such as computing system 100 (FIG. 1) and displayed on a computer monitor such as monitor 104 (FIG. 1).

In this example, GUI 270 includes a title bar 272 that lists the name and specific implementation of app_2 114, or “joseph_smith@us.ibm.com—IBM Workplace.” In other words, GUI 270 is an exemplary display of an email box associated with IBM Workplace and the hypothetical user Joseph Smith. Title bar 272 includes several action buttons 274, or a “Minimize” button, a “Restore” button and an “Exit” button. Below title bar 272 is a menu bar 276, which includes a “File” option, “Edit” option, “View” option, “Actions” option, “Tools” option, “Window” option and “Help” option. The standard look and feel of a IBM Workplace application should be familiar to those with skill in the art.

Below menu bar 276 is a title bar 278 that identifies the portion of app_2 114 that is currently on display in a display box 280, i.e. a “Documents” section. On the left side of display box 280 are a number of iconic buttons 282, only one of which is enumerated. The enumerated iconic button is highlighted to indicate that the corresponding portion of app_2 114, i.e. the Documents portion, is on display. Other possible displays associated with IBM workplace and corresponding iconic buttons 282 may include, but are not limited to, such items as Messaging, a Lotus Notes utility, Activity Explorer, Web Conferencing and a Web Browser.

Display box 280 includes a Document Libraries section 284 and a Detail section 286. Horizontal scroll bars on the bottom of Document Libraries 284 and Detail section 286 enable portions of the corresponding displays that are not displayed due to size constraints of monitor 104 to be scrolled into view. Top level folders included in Document Libraries section 284 include an email folder 288 and a Jim Public Library folder 300. Email folder 288 includes an Admin sub-folder 290, a Travel sub-folder 292, with includes a Trip_1 sub-folder 294 and a Trip_2 sub-folder 296, and a Project sub-folder 298. Like GUI 200, it should be noted that the illustrated folders and sub-folders of GUI 270 are used only for the sake of examples and any particular implementation of the claimed subject matter may include additional, different, less and/or the same folders.

Detail section 286 of display box 280 displays information on the highlighted folder of section 284, i.e. Travel folder 292. A number of action buttons 302 enable a user to execute specific action with respect to entries displayed in Detail Section 286. A Title column 304 shows the names of folders or documents in the corresponding folder Travel 292, an Author's column 306 shows the corresponding author and a Type column 308 shows a type of the corresponding entry. An information bar 310 displays statistics about the Detail section 286. In this example information bar 310 indicates that Detail section includes two (2) folders and zero (0) documents.

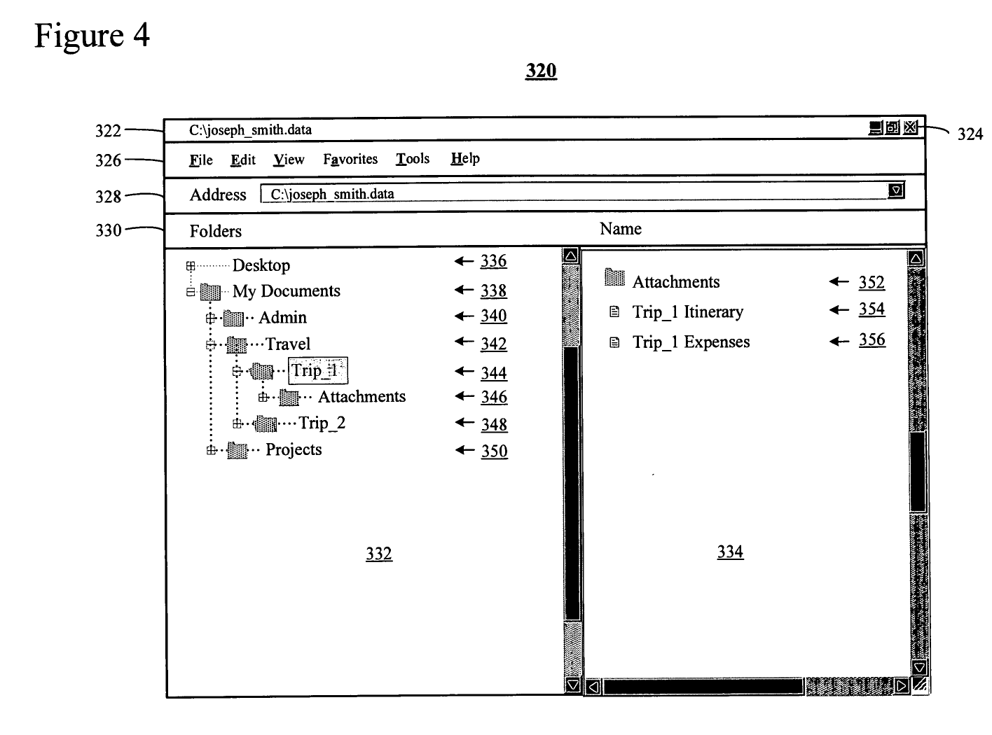

FIG. 4 is a block diagram of a GUI 320 associated with a third hierarchical structure, i.e. a Windows operating system, which in this example is OS 120 (FIG. 1) and the associated file system 111. Like GUIs 200 and 270, GUI 320 is typically executed on a computing system such as computing system 100 (FIG. 1) and displayed on a computer monitor such as monitor 104 (FIG. 1).

In this example, GUI 320 includes a title bar 322 that lists a particular directory on display, i.e. C:\joseph_smith.data. In other words, GUI 320 is an exemplary display of a directory structure associated with the Windows OS 120 and the hypothetical user Joseph Smith. Title bar 322 includes several action buttons 324, or a “Minimize” button, a “Restore” button and an “Exit” button. Below title bar 322 is a menu bar 326, which includes a “File” option, “Edit” option, “View” option, “Favorites” option, “Tools” option and “Help” option. An address bar 328 enables the user to navigate directory associated with computing system 100 and OS 120. The standard look and feel of this type of GUI associated with Windows OS 116 should be familiar to those with skill in the art.

A Directory display 332 shows the current contents of the directories associated with the directory identified in address box 328. A vertical scroll bar on the right side of Directory display 332 enables entries that are not displayed due to size constraints of monitor 104 to be scrolled into view. Directory display 332 includes entries for a two (2) top-level directories, i.e. a Desktop directory 336 and a My Documents directory 338. My Documents directory 338 includes an Admin directory 340, a Travel directory 342 and a Projects directory 350. Travel directory 342 includes a Trip_1 directory 344, which itself has an Attachments sub-directory 346, and a Trip_2 directory 348. The name of Trip_1 directory 344 is highlighted to indicate that detail of Trip_1 directory 344 is displayed in a Detail section 334.

Detail section 334 shows the entries of Trip_1 directory 344, i.e. Attachments folder 346 and two (2) documents, a Trip_1 Itinerary file 354 and a Trip_1 Expenses file 356. Horizontal and vertical scroll bars on the bottom and right side, respectively, of Detail display 334 enables entries that are not displayed due to size constraints of monitor 104 to be scrolled into view.

Hierarchical structures represented by GUIs 200, 270 and 320 are used in the following figures to illustrate how information is moved according to the claimed subject matter among hierarchical structures. The three hierarchical structures are used as examples and it should be understood that the claimed subject matter applies equally well to any other existing and yet to be developed hierarchical structures, or which there are now and will be in the future many. Although the hierarchical information structure represented by GUI 270 is not employed in the following examples, those with skill in the computing arts should appreciate how the disclosed technology might be implemented to enable the system represented by GUI 270 to access information and attachments stored in accordance with the following description by the systems represented by GUIs 200 and 320.

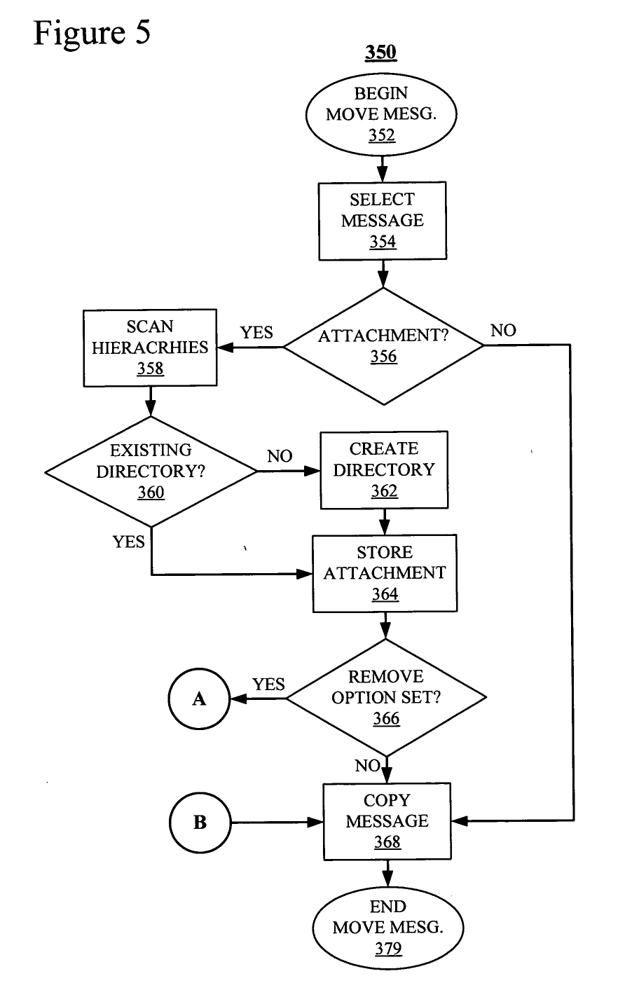

FIG. 5 is a flowchart of an exemplary Move Message process 350 for implementing one aspect of the claimed subject matter. The following examples as described in conjunction with FIGS. 5-7 employ elements of the information hierarchies represented by GUI 200 and GUI 320 described above in conjunction with FIGS. 2 and 4, respectively. Specifically, email message “Travel Dept” of column 252 (FIG. 2) is moved with corresponding attachment 254 (FIG. 2) to Trip_1 sub-folder 240 (FIG. 2) of Directory Structure 218 (FIG. 1). This example describes the changes implemented to the hierarchies represented by GUIs 200 and 320. Process 350 is implemented by IMPI_1 116 (FIG. 1) executing on CPU 102 (FIG. 1).

Process 350 starts in a “Begin Move Message” block 352 and proceeds immediately to a “Select Message” block 354. During block 354, a user selects an email message to move. As explained above, in this example, email message Travel Dept. is selected by a user to move from Inbox 220 to Trip_1 folder 240. An email move operation may be initiated either by “clicking” on the Move button 248, i.e. positioning a cursor (not shown) over the Move button 248 and pressing on the mouse 108 (FIG. 1), or executing a “drag-and-drop” operation, i.e. positioning the cursor over the Travel Dept email, pressing on mouse 108, repositioning the cursor over Trip_1 folder 240 by moving the mouse, and releasing the button on mouse 108. Those with skill in the computing arts should understand how to execute a move of a file from one folder to another.

It should be noted that although process 350 is described below as executing on a message selected by a user, the claimed subject matter could also be implemented apply automatically on email messages as the messages are received by a particular hierarchical information system. Whether the claimed subject matter is executed by a user on specific email messages or applied to all messages as they are received may also be determined by a configuration option associated with the system in which the disclosed technology is implemented.

During an “Attachment?” block 356, process 350 determines whether or not the email selected during block 354, or the “targeted” email message, includes an attachment. If not, process 350 proceeds to a “Copy Message” block 368 during which the targeted email is simply moved in a conventional manner to the designated target folder, or, in this example, Trip_1 folder 240. If, during block 356, process 350 determines that the targeted email message includes an attachment, then control proceeds to a “Scan Hierarchies” block 358 during which process 350 determines the information hierarchical structures of both the hierarchical information system from which the email is originating and the hierarchical information system which is the designated target for the attachment. In this example, the designated target is the file system of OS 120 (FIG. 1) as represented by GUI 320. The designated target is determined on the basis of options stored in conjunction with IMPI_1 116.

During an “Existing Directory?” block 360, process 350 determines whether or not the targeted hierarchical structure includes directories that correspond to the folder/sub-folder system of the originating hierarchical information structure. In the present example, process 350 determines if OS 120 includes a directory tree corresponding to Folders 222 (FIG. 2), Travel 238 (FIG. 2) and Trip_1 240 of the IBM Lotus Notes system of GUI 200. It should be noted that the mapping form one information system to another does not need to be exact. For example, IMPI_1 116 may be configured to map Folders 222 to My Documents directory 338 (FIG. 4) of OS 120. Once Folders 222 is mapped to My Documents 338, process 350 maps Travel folder 238 to Folder directory 342 and Trip_1 folder 240 to Trip_1 directory 344 (FIG. 4). If process 350 determines that appropriate mappings between the two hierarchical systems exist, then control proceeds to a “Store Attachment” block 364 during which targeted attachment is stored in Trip_1 directory 344. In the alternative, the targeted attachment is stored in a designated “Attachments” directory 352 (FIG. 4) created specifically for organizing attachments stored according to the disclosed methods.

If during block 360 process 350 determines that an appropriate mapping between the originating and target hierarchical information systems does not exist, then control proceeds to a “Create Directory” block 362 during which the appropriate directories are created in the target hierarchical information system. Process 350 then proceeds to Store Attachment block 364 during which, as described above, the targeted attachment is stored in the target directory.

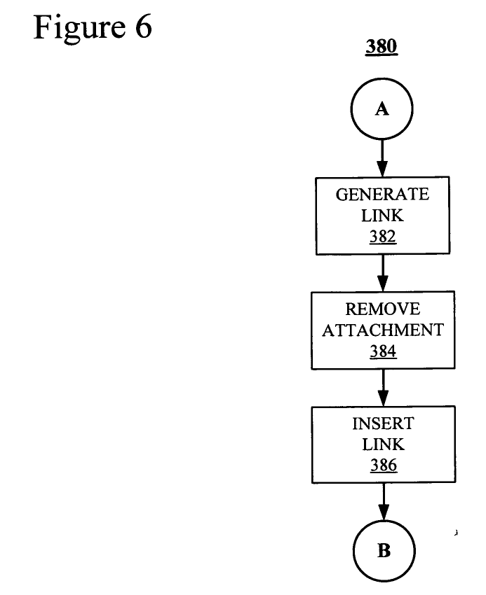

During a “Remove Option Set?” block 366, process 350 determines whether or not IMPI_1 116 is configured to remove the original attachment form the first hierarchical information system. If so, process 350 proceeds to a Transition Point A. The processing that is executed following a change of control to transition point A is described in more detail below in conjunction with FIG. 6. If during block 366 process 350 determines that IMPI_1 116 is not configured to remove the original attachment form the first hierarchical information system, process 350 proceeds to “Copy Message” block 368 and both the target email and the corresponding attachment are moved to the target folder.

A Transition Point B, described below in more detail below in conjunction with FIG. 6, passes control to Copy Message block 368. In this case, the attachment has been handled differently than if block 368 was entered via block 366. As described below in conjunction with FIG. 6, the target email message and a link to the corresponding attachment stored in the file system of the target hierarchical information system are stored in the folder system of the originating hierarchical information system. Finally, control proceeds from Copy Message block 368 to an “End Move Message.” block 379 in which process 350 is complete.

FIG. 6 is a flowchart of a process 380 that represents one portion of Move Message process 350 first introduced above in conjunction with FIG. 5. Process 380 starts at Transition Point A (FIG. 5) and proceeds immediately to a “Generate Link” block 382 during which process 380 generates a link to the attachment stored in conjunction with Store Attachment block 364 (FIG. 5). A link is a reference to an existing file that redirects a file retrieval process from the location of the link to the actual location of the file.

During a “Delete Attachment” block 384, process 380 deletes the attachment form the originating folder when the email message is moved form the originating folder to the target folder, e.g. from Inbox 220 to Trip_1 240. The attachment is not copied to the target folder. During an “Insert Link” block 386, process 380 inserts the link generated during block 382 into the destination folder, storing the link rather than the attachment in conjunction with the corresponding email message. Finally, process 380 proceeds to Transition Point B in which control proceeds to Copy Message block 368 (FIG. 5) and processing continues as described above in conjunction with FIG. 5.

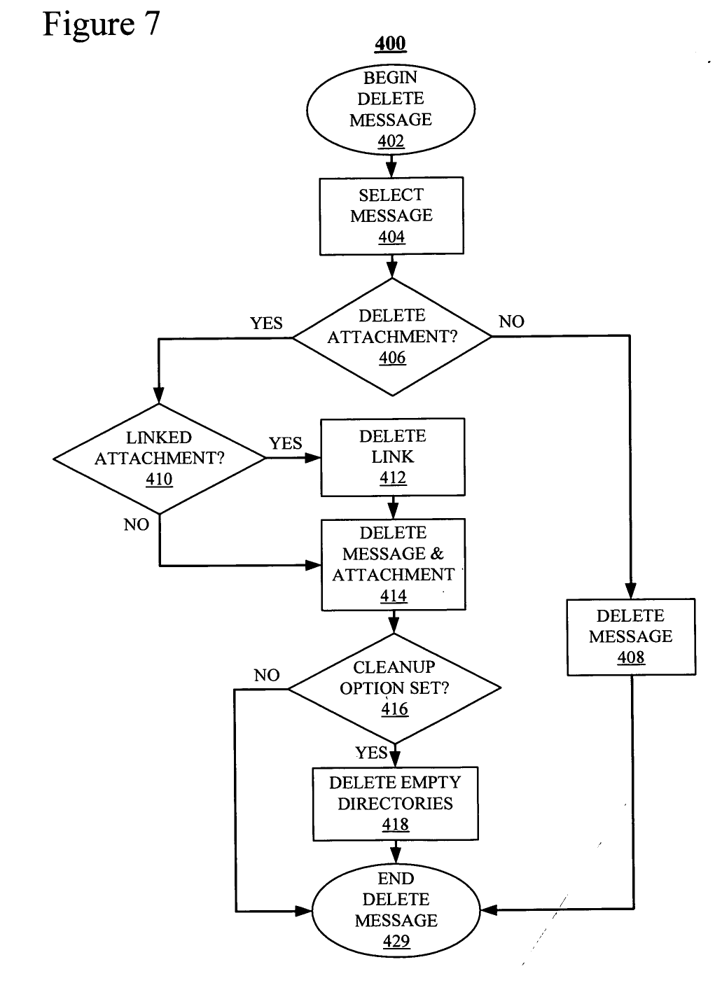

FIG. 7 is a flowchart of an exemplary Delete Message process 400 for implementing the claimed subject matter. Like process 350 (FIG. 5), in this example, process 400 is implemented by IMPI_1 116 (FIG. 1) executing on CPU 102 (FIG. 1).

Process 400 starts in a “Begin Delete Message” block 402 and proceeds immediately to a “Select Message” block 404 during which a user selects an email message to delete. In this example, email message Travel Dept. is selected by a user to delete from Trip_1 folder 240 where folder 240 would be stored after executing the example above with respect to process 300 (FIG. 5). An email delete operation may be initiated either by “clicking” on the Delete button 248, i.e. positioning a cursor (not shown) over Delete button 248 and pressing on the mouse 108 (FIG. 1), or executing a “drag-and-drop” operation, i.e. positioning the cursor over the Travel Dept email, pressing on mouse 108, repositioning the cursor over a Deleted Files icon (not shown) by moving the mouse, and releasing the button on mouse 108.

During a “Delete Attachment?” block 406, process 400 determines whether or not the email message selected during block 404 includes an attachment that the user desires to delete in addition to the message. Process 400 may make this determination based upon settings stored in conjunction with the particular email message or based upon the user's response to a pop-up window (not shown). If there is either no attachment stored in conjunction with the selected email or the user has indicated that an attachment should not be deleted, process proceeds to a “Delete Message” block 408 during which the selected email message is deleted by the corresponding hierarchical information system's standard deletion procedures. Control then proceeds to an “End Delete Message” block 429 in which process 400 is complete.

If during block 406, process 400 determines there is an attachment corresponding to the message selected during block 404 that the user would like deleted, control proceeds to a “Linked Attachment?” block 410. During block 410, process 400 determines whether or not the attachment corresponding to the file selected during block 404 is referenced by a link to the document stored by the second hierarchical information system. If so, during a “Delete Link” block 412, process 400 deletes the link. Following block 412 or if process 400 determines during block 410 that there is no link, control proceeds to a “Delete Message & Attachment” block 414 during which process 400 deletes both the selected message and the corresponding attachment, regardless of where the attachment is stored.

During a “Cleanup Option Set” block 416, process 400 determines whether or not a configuration option stored, in this example in conjunction with IMPI_1 116, specifies that empty directories should be removed. If not, process 400 proceeds to End Delete Message block 429 in which process 400 is complete. If process 400 determines during block 416 that the cleanup option is selected, then control proceeds to a “Delete Empty Directories” block 418 during process examines nodes in the directory tree corresponding to the deleted attachment and deletes those nodes that are empty. Finally process 400 proceeds to “End Delete Message” block 429 in which process 400 is complete.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A computer implemented method for organizing data for access by two or more information management systems, each of the information management system having an organizational structure, comprising:
comparing the organizational structures of information in a first information management system and a second information management system;
creating in said first information management system an organization proxy for said second information management system organizational structure of information;
creating in said second information management system an organizational proxy for said first information management system organizational structure of information; and
making data content in both said first and second information management systems accessible from either said first or second information management systems according to that system's organizational structure.

2. The method of claim 1, further comprising:
storing a first portion of the data content in the first information management system; and
storing a second portion of the data content in the second information management system.

3. The method of claim 2, further comprising storing, in conjunction with the first portion of the data content, a link from the first portion of the data content to the second portion of the data content.

4. The method of claim 3, wherein the first portion of the data content is an email message and the second portion of the data content is an attachment to the email message.

5. The method of claim 4, wherein the storing of the first portion and the second portion is executed automatically as the email is received by the first information management system.

6. The method of claim 4, wherein the storing of the first portion and the second portion is executed in response to a user request.

7. The method of claim 1, wherein the first information management system is an email management system and the second information management system is a directory structure associated with an operating system.

8. A system for organizing data for access by two or more information management systems, each of the information management system having an organizational structure, comprising:
a first informational management system;
a second informational management system;
a first organization proxy in the first information management system corresponding a first organizational structure of information of the second information management system;
a second organization proxy in the second information management system corresponding a second organizational structure of information of the first information management system; and
logic for making data content in both the first and second information management systems accessible from either the first or second information management systems according to that system's organizational structure.

9. The system of claim 8, further comprising:
logic for storing a first portion of the data content in the first information management system; and
logic for storing a second portion of the data content in the second information management system.

10. The system of claim 9, further comprising:
a link from the first portion of the data content to the second portion of the data content; and
logic for storing, in conjunction with the first portion of the data content, the link.

11. The system of claim 10, wherein the first portion of the data content is an email message and the second portion of the data content is an attachment to the email message.

12. The system of claim 11, wherein the storing of the first portion and the second portion is executed automatically as the email is received by the first information management system.

13. The system of claim 11, wherein the storing of the first portion and the second portion is executed in response to a user request.

14. The system of claim 8, wherein the first information management system is an email management system and the second information management system is a directory structure associated with an operating system.

15. A computer programming product for organizing data for access by two or more information management systems, each of the information management system having an organizational structure, comprising:
a memory;
logic, stored on the memory, for comparing the organizational structures of information in a first information management system and a second information management system;
logic, stored on the memory, for creating in said first information management system an organization proxy for said second information management system organizational structure of information;
logic, stored on the memory, for creating in said second information management system an organizational proxy for said first information management system organizational structure of information; and
logic, stored on the memory, for making data content in both said first and second information management systems accessible from either said first or second information management systems according to that system's organizational structure.

16. The computer programming product of claim 15, further comprising:
logic, stored on the memory, for storing a first portion of the data content in the first information management system; and
logic, stored on the memory, for storing a second portion of the data content in the second information management system.

17. The computer programming product of claim 16, further comprising logic, stored on the memory, for storing, in conjunction with the first portion of the data content, a link from the first portion of the data content to the second portion of the data content.

18. The computer programming product of claim 17, wherein the storing of the first portion and the second portion is executed automatically as the email is received by the first information management system.

19. The computer programming product of claim 17, wherein the storing of the first portion and the second portion is executed in response to a user request.

20. The computer programming product of claim 15, wherein the first information management system is an email management system and the second information management system is a directory structure associated with an operating system.
